(19) United States
(12) Patent Application Publication
(10) Pub. No.: US 2023/0167564 A1
(43) Pub. Date: Jun. 1, 2023

(54) SYSTEM FOR PRODUCING AND REGULATING THE PRODUCTION AND DISTRIBUTION OF HYDROGEN FROM AN ELECTROLYZER AND NON-ELECTROLYZER SOURCE

(71) Applicants: Dante P. Bonaquist, Boalsburg, PA (US); Monica Zanfir, The Woodlands, TX (US); John D. Sirman, Wappingers Falls, NY (US); Minish Mahendra Shah, E. Amherst, NY (US)

(72) Inventors: Dante P. Bonaquist, Boalsburg, PA (US); Monica Zanfir, The Woodlands, TX (US); John D. Sirman, Wappingers Falls, NY (US); Minish Mahendra Shah, E. Amherst, NY (US)

(21) Appl. No.: 17/539,815

(22) Filed: Dec. 1, 2021

(51) Int. Cl. C25B 15/08; C25B 5/00; C25B 1/042; C25B 15/02

(52) U.S. Cl. CPC C25B 15/081; C25B 5/00; C25B 1/042; C25B 15/02; C25B 15/083; G06Q 50/06

(57) ABSTRACT

The disclosure relates, inter alia, to a system comprising: (1) an electric power grid; (2) an electrolyzer generating a first stream of hydrogen in communications link with the electric power grid; (3) hydrogen production means for producing a second stream of hydrogen, said hydrogen production means being a non-electrolyzer in communications link with the electrolyzer; (4) a first conduit leading to a hydrogen user through which hydrogen flows to the hydrogen user; (5) a second conduit connecting the electrolyzer to the first conduit through which hydrogen from the electrolyzer flows to the first conduit at a first location; (6) a third conduit distinct from the second conduit connecting the non-electrolyzer to the first conduit through which hydrogen from the non-electrolyzer flows to the first conduit at a second location distinct from the first location; and (7) means for controlling and maintaining a continuous flow of hydrogen to the hydrogen user.

### FIELD OF THE DISCLOSURE

The present disclosure relates to a system of regulating hydrogen production and distribution of hydrogen gas from an electrolyzer producing hydrogen and a non-electrolytic hydrogen source and the process of regulating the production of hydrogen from an electrolyzer and a non-electrolyzer source.

### BACKGROUND

Hydrogen is an important industrial gas, widely used in oil refining, and in production of synthetic fuels, ammonia, and methanol. Hydrogen is most valuable when consumed as an essentially pure fuel or industrial chemical. Hydrogen also is being considered for future use in hydrogen vehicles powered by hydrogen fuel cell engines or hydrogen internal combustion engines (or hybrid hydrogen vehicles, also partially powered by batteries).

Electrolysis is one method of producing hydrogen. Electrolyzers use DC or AC electricity to transform reactant chemicals to desired product chemicals, such as hydrogen, through electrochemical reactions, i.e., reactions that occur at electrodes that are in contact with an electrolyte. Electrolyzers that can produce hydrogen include, but not limited to, water electrolyzers, which produce hydrogen and oxygen from water and electricity; ammonia electrolyzers, which produce hydrogen and nitrogen from ammonia and electricity; and chlor-alkali electrolyzers, which produce hydrogen, chlorine and caustic solution from brine and electricity.

Water electrolyzers are the most common type of electrolyzer used to produce gaseous hydrogen. The most common type of commercial water electrolyzer currently is the alkaline water electrolyzer. Other types of water electrolyzers include PEM water electrolyzers, currently limited to relatively small production capacities, and solid oxide water electrolyzers, which have not been commercialized. Alkaline water electrolyzers utilize an alkaline electrolyte in contact with appropriately catalyzed electrodes. These water electrolyzers break hydrogen and oxygen bonds in water to produce hydrogen and oxygen gases. Hydrogen is produced at the surfaces of the cathodes (negative electrodes), and oxygen is produced at the surfaces of the anodes (positive electrodes) upon passage of current between the electrodes. The rates of production of hydrogen and oxygen are proportional to the DC current flow in the absence of parasitic reactions and stray currents, and for a given physical size of electrolyzer.

However, for commercial applications, the electricity required for electrolysis is mainly derived from the electric power grid, i.e., an AC power grid. Electrical power is generated at various types of power generating stations and is fed into a power grid to supply and meet the demands of not only commercial consumers, but also domestic and industrial consumers. Power distribution stations handle the transmission and distribution of electric power from the power generating stations to the ultimate consumers. Typically, the demand for electrical power from the various types of consumers varies.

Grid services include various services that help maintain reliable operation of a grid. A grid system operator may offer contracts for various kinds of grid services. Grid services include operations that assist an electrical grid operator in managing a control area or that can be used to either reduce or facilitate energy transfers between control areas. Of particular interest herein, some grid service contracts require the owner of a variable load to respond to dispatch orders made by a grid system operator for the purpose of balancing total production and consumption on the grid, for example, to avert or correct a short-term imbalance. The most significant loads in a grid tend to be industrial processes. However, industrial processes tend to operate most efficiently at steady states, and so only some industrial processes may be used to provide grid services, and the potential value of their grid services is typically small.

To provide grid services, a process is required to operate at least with a variable rate of power consumption. The potential value of the grid services that can be provided by a variable load are increased a) if the rate, frequency, or size of the potential change in power consumption is increased, b) if the process is able to operate accurately at a specified rate of power consumption or c) if the process can be controlled by the grid operator.

The rate, frequency, and size of a change in power consumption is relevant to the value of grid services because very few loads or power generating assets are able to alter their consumption or production quickly, frequently or by a large amount. Integrating high levels of renewable energy generating assets in a grid therefore requires a corresponding increase in the ability to alter other assets frequently and quickly, and to a corresponding degree.

The ability to operate accurately at a specified rate of power consumption is valuable since a load that can follow dispatch orders precisely helps provide faster and simpler resolution of imbalances than a less precise asset. In market-based systems, reduced costs may only apply to a specified consumption.

To provide grid services, a process is required to operate at least with a variable rate of power consumption, and simultaneously, maintain the flow of hydrogen gas to the user at a steady state at some prescribed pressure or threshold pressure.

Voltage regulation is typically provided at the sub-station level to maintain steady voltages at the user terminals at desired levels. Ideally, the voltage delivered via an AC transmission and distribution system should be constant in amplitude and frequency. However, in practice, the voltage may vary somewhat. In certain exemplary cases, voltage may vary due to fluctuations at the production end or to a cut in power due to power outages. In other exemplary cases, the voltage may vary due to variations in demand.

Regarding the rate, frequency, and magnitude of changes in power consumption, most industrial processes are constrained in their ability to respond to a requested change by one or more of a limited range of efficient process operations, or mechanical components used in the process, and/or the need to produce a product. The mechanical components wear out or fail more frequently when they are not operated in steady states. The rate of product production may need to satisfy physical or market constraints. Regarding the ability to operate at a specified rate of power consumption, most industrial processes are controlled by specifying a production rate, not by specifying power consumption. Regarding control by the grid operator, this interferes with the industrial manager's ability to optimize this process according to other constraints.

To increase its potential to provide grid services, a system for electrolytic production of hydrogen is needed to be configured to have one or more of the abilities to operate at frequently, quickly, or widely variable rates or electricity consumption, to operate at a specified rate of power consumption and to operate under the control by a grid operator.

Electrolytic production of hydrogen responds to signals from the grid system operator. However, during times of increased demand of electrical power from consumers, electrolytic production of hydrogen may decrease. Thus, the electrolytic production of hydrogen becomes variable, which is not acceptable to customers, i.e., hydrogen gas users, who require a continuous supply of hydrogen. Many processes that use hydrogen, petroleum refineries, chemical plants, metallurgical operations to name a few, operate efficiently and cost effectively only when the supply of hydrogen is continuous. There is, therefore, a need to provide a continuous flow of hydrogen to these hydrogen gas users that avoids the variability of the flow of hydrogen gas from the power grids.

The present disclosure addresses this problem; it provides a system and a method to maintain a continuous supply of hydrogen to customers in circumstances when the production of hydrogen is variable as a result from the increase of demand of electricity from power grids. More specifically, the present disclosure provides a system to maintain a continuous flow of hydrogen gas to the downstream hydrogen gas customers by incorporating the electrolyzer into a system that uncouples the instantaneous production of electrolyzer hydrogen from the downstream customer demand and incorporating the electrolyzer into a system with a hydrogen supply system of other hydrogen production sources.

### SUMMARY OF THE DISCLOSURE

The present disclosure provides a system and a method of integrating electrolyzers used for grid regulation with a hydrogen gas supply system consisting of non-electrolytic hydrogen gas sources such as SMRs (steam methane reformers), pipelines and hydrogen storage facilities, making it possible to maintain a continuous supply of hydrogen gas to the hydrogen gas user without interruption, even at times when there is variable output of electricity from power grids. More specifically, in an embodiment, the present disclosure relates to a system which comprises (1) an electric power grid; (2) an electrolyzer for generating a first stream of hydrogen gas at a predetermined baseline rate, wherein the electrolyzer is in communications link with the electric power grid capable of providing grid services to transmission and distribution system operators, and delivering electricity to the electrolyzer; (3) hydrogen gas production means, other than an electrolyzer, for producing a second stream of hydrogen gas, said hydrogen gas production means being a non-electrolyzer in communications link with the electrolyzer; (4) a first conduit leading to a hydrogen gas user through which a mixed stream of hydrogen gas comprised of the first stream of hydrogen gas and the second stream of hydrogen gas flows to the hydrogen gas user at the exit end thereof; (5) a second conduit connecting the electrolyzer to the first conduit and through which flows the first stream of hydrogen gas produced by the electrolyzer into the first conduit at a first flow rate; (6) a third conduit connecting the non-electrolyzer to the first conduit and through which flows a second stream of hydrogen gas produced by the non-electrolyzer at a second flow rate, the second stream of hydrogen gas entering the first conduit at a location different from where the first stream of hydrogen gas in the second conduit enters the first conduit, wherein the second conduit and the third conduit are separate conduits; and (7) a means for compensating in fluctuations of hydrogen gas production from the electrolyzer for maintaining a continuous flow of hydrogen gas to the hydrogen gas user. In an embodiment, the electrolyzer is in communications link with a controller, which is also in communications link with the power grid, said controller configured for monitoring the electricity generated from the electric power grid to the electrolyzer and operative for communicating to the electrolyzer, such as transmitting a signal to the electrolyzer, to increase or decrease the production rate of hydrogen gas relative to a baseline rate. In a further embodiment, the hydrogen gas production means is a steam methane reformer (SMR). Thus, in an embodiment, the electrolyzer for producing a first stream of hydrogen gas is coupled to a steam methane reformer (“SMR”), which produces a second stream of hydrogen gas, in which the first stream of hydrogen gas produced by the electrolyzer and the second stream of hydrogen gas produced by the SMR are produced in parallel streams in the system; a communications link between the electrolyzer and SMR through which the electrolyzer communicates to the SMR, such as by transmitting a signal to the SMR, to increase or decrease production output of the second stream of hydrogen gas; a controller in communication link with the electrolyzer, which is capable of transmitting a signal to the electrolyzer to increase or decrease production output of the first stream of hydrogen gas; a second conduit connecting the electrolyzer to the first conduit and through which flows the first stream of hydrogen gas produced by the electrolyzer into the first conduit; a third conduit connecting the SMR to the first conduit and through which flows the second stream of hydrogen gas produced by the SMR into the first conduit at a location different from where the first stream of hydrogen gas in the second conduit flows into the first conduit, wherein the second conduit and the third conduit are separate conduits. In another embodiment, the system additionally comprises a pressure controller capable of monitoring the pressure of the mixed hydrogen gas stream in the first conduit at a location downstream from where the first stream of hydrogen gas produced by the electrolyzer flows from the second conduit into the first conduit and downstream from where the second stream of hydrogen gas produced by the non-electrolyzer, such as the SMR, flows from the third conduit into the first conduit and upstream from the exit end of the first conduit at the hydrogen gas user. In another embodiment, the system additionally comprises a first compressor, in communication links with the pressure controller, capable of increasing or decreasing the pressure of the mixed stream of hydrogen gas flowing in the first conduit, wherein the first compressor is located at a position downstream from where the first stream of hydrogen gas produced by the electrolyzer and the second stream of hydrogen gas produced by the non-electrolyzer, such as SMR, flows into the first conduit and upstream from the exit end of the first conduit at the hydrogen gas user. In a further embodiment, the system additionally comprises a first valve located on the first conduit through which the mixed stream of hydrogen gas in the first conduit flows to the hydrogen gas user, wherein the first valve is downstream from where the first stream of hydrogen gas produced by the electrolyzer flows from the second conduit into the first conduit and downstream from where the second stream of hydrogen gas produced by non-electrolyzer, such as SMR, flows from the third conduit into the first conduit and upstream from where the mixed stream of hydrogen gas exits from the first conduit at the hydrogen gas user. In an even further embodiment, the system additionally comprises a second compressor, located on the second conduit downstream from the electrolyzer, capable of compressing the first stream of hydrogen gas produced from the electrolyzer. In another embodiment, the system additionally comprises a dryer located on the second conduit capable of removing water present in the first stream of hydrogen gas produced by the electrolyzer, this dryer being located downstream from the electrolyzer and upstream from where the first stream of hydrogen gas flowing in said conduit from the electrolyzer flows into the first conduit. In an embodiment, the system additionally comprises a hydrogen gas storage facility; a fourth conduit connecting the hydrogen gas storage facility to the first conduit for diverted flow of the mixed stream of hydrogen gas from the first conduit to the hydrogen gas storage facility, said fourth conduit located downstream from where the first stream of hydrogen gas produced by the electrolyzer flows from the second conduit into the first conduit and downstream from where the second stream of hydrogen gas produced by the non-electrolyzer, such as SMR, flows from the third conduit into the first conduit and upstream from the exit end of the first conduit at the hydrogen gas user; and a fifth conduit connecting the hydrogen gas storage facility to the first conduit for the flow of a third stream of hydrogen gas from the hydrogen gas storage facility to the first conduit, said fifth conduit connecting the first conduit at a location downstream from where the fourth conduit connects to the first conduit (and if present, downstream from the location of the pressure controller capable of monitoring the hydrogen gas pressure of the mixed stream of hydrogen gas flowing in the first conduit) and upstream from the exit end of the first conduit at the hydrogen gas user. In another embodiment, the previous embodiment further comprises a second valve located on the fifth conduit for controlling the flow of the third stream of hydrogen gas exiting from the hydrogen gas storage facility to the first conduit, said second valve configured to open or close to permit or stop, respectively, the flow of the third stream of hydrogen gas to the first conduit. In a still further embodiment, the present disclosure relates to system for producing hydrogen gas, which additionally comprises the pressure controller being in communication link with the non-electrolyzer, such as SMR, transmitting a signal which is capable of adjusting the second stream of hydrogen gas production by the non-electrolyzer. In another embodiment, the present disclosure relates to a system for producing hydrogen gas, which additionally comprises a turbine located on the fifth conduit downstream from the hydrogen gas storage facility, capable of converting the hydrogen gas flowing in the fifth conduit from the hydrogen gas storage facility into mechanical energy and if connected to a generator, to electrical energy. In still further embodiment, the previous embodiment is further modified in that hydrogen gas from the hydrogen gas storage facility flows through the turbine to create mechanical energy and if connected to a generator, to electrical energy, the remainder of the flow of hydrogen gas in the fifth conduit from the hydrogen gas storage facility flows into the first conduit. In an embodiment, the system additionally comprises a hydrogen gas liquefier, a sixth conduit connected to the first conduit, wherein the sixth conduit is connected to the first conduit at a location upstream of the exit end of the first conduit at the hydrogen gas user and downstream from where the first stream of hydrogen gas produced by the electrolyzer flows from the second conduit into the first conduit and downstream from where the second stream of hydrogen gas produced by the non-electrolyzer, such as SMR, flows from the third conduit into the first conduit. In a further embodiment, the previous embodiment additionally comprises a liquid hydrogen reservoir and a seventh conduit connecting the hydrogen gas liquefier to the hydrogen gas liquefier reservoir.

In an embodiment, a means for compensating for fluctuations of hydrogen gas production from the electrolyzer comprises a signal or other type of communication from the electrolyzer to the non-electrolyzer through the communications link to increase the output of hydrogen gas from the non-electrolyzer at a rate sufficient for maintaining the mixed stream of hydrogen gas flowing to the hydrogen gas user at the predetermined rate during a decrease in electricity flow to the electrolyzer relative to a baseline and a decrease in hydrogen production therefrom. In a further embodiment, a means for compensating for fluctuations of hydrogen gas production from the electrolyzer comprises a signal or other type of communication from the electrolyzer to the non-electrolyzer through the communications link to decrease the output of hydrogen gas from the non-electrolyzer at a rate sufficient for maintaining the mixed stream of hydrogen gas flowing to the hydrogen gas user at the predetermined rate during an increase in electricity output to the electrolyzer relative to a baseline and an increase in hydrogen gas production therefrom. In another embodiment, a means for compensating fluctuations of hydrogen gas production from the electrolyzer comprises a signal from the pressure controller to the first compressor, causing the second valve to open and the third stream of hydrogen gas to flow from the hydrogen gas storage facility into the first conduit at a rate sufficient for maintaining the mixed stream of hydrogen gas flowing to the hydrogen gas user at the predetermined rate during a decrease in electricity flow to the electrolyzer relative to a baseline and a decrease in hydrogen gas production therefrom. In another embodiment, a means for compensating for fluctuations of hydrogen gas production from the electrolyzer comprises a signal from the pressure controller to the first compressor, causing the second valve to close and a portion of the mixed stream of hydrogen gas to be diverted to flow from the first conduit into the fourth conduit to the hydrogen gas storage facility at a rate sufficient for maintaining the mixed stream of hydrogen gas flowing to the hydrogen gas user at the predetermined rate during an increase in electricity flow to the electrolyzer relative to a baseline and an increase in hydrogen gas production therefrom.

In another embodiment, the present disclosure relates to a process for producing hydrogen gas to a hydrogen gas user which comprises: (1) providing an electrolyzer generating a first stream of hydrogen gas which is in communication link with an electric power grid, said electric power grid providing a baseline of electricity to the electrolyzer; (2) providing a hydrogen gas production means for producing a second stream of hydrogen, said hydrogen gas production means being a non-electrolyzer in communication link with the electrolyzer; (3) coupling the hydrogen gas production of the electrolyzer with the hydrogen gas production from the non-electrolyzer and controlling the amount of the first stream of hydrogen gas and the second stream of hydrogen gas being produced; (4) mixing the first stream of hydrogen gas with the second stream of hydrogen gas to form a mixed stream of hydrogen gas that flows at a predetermined rate to the hydrogen gas user; (5) transporting the mixed stream of hydrogen gas to the hydrogen gas user and (6) compensating for fluctuations of hydrogen gas production from the electrolyzer to maintain a continuous flow of the mixed stream of hydrogen gas to the hydrogen gas user at a predetermined rate In another embodiment, the non-electrolyzer is a steam methane reformer. In another embodiment, a hydrogen gas storage facility for storing hydrogen gas is additionally present. In an embodiment, a portion of the mixed stream of hydrogen gas is diverted to the hydrogen gas storage facility and/or the output of hydrogen gas produced by the non-electrolyzer into the second stream is decreased at a rate sufficient to maintain the predetermined rate of flow of the mixed hydrogen gas stream to the hydrogen gas user when the electricity from the electric power grid to the electrolyzer is above the baseline and/or when the stream of mixed hydrogen gas to the hydrogen gas user is above the predetermined rate. In another embodiment, hydrogen gas is released from the hydrogen gas storage facility to the mixed stream of hydrogen gas flowing to the hydrogen gas user and/or the output of hydrogen gas from the non-electrolyzer is increased when the electricity from the electric power grid flowing to the electrolyzer is below the baseline to the electrolyzer and/or when the stream of the mixed hydrogen gas to the hydrogen gas user is below the predetermined rate. In an embodiment, the process comprises monitoring the hydrogen gas pressure in the mixed stream of hydrogen gas. In another embodiment, the process comprises controlling the flow of the mixed hydrogen gas to the hydrogen gas user by passing the mixed hydrogen gas stream through a first valve located upstream from where the mixed hydrogen gas stream flows to the hydrogen gas user and downstream from where the first stream and the second stream of hydrogen gas mixes to form the mixed stream of hydrogen gas. In another embodiment, the process additionally comprises compressing the first stream of hydrogen gas prior to mixing with the second stream of hydrogen gas. In another embodiment, the process additionally comprises drying the first stream of hydrogen gas in a drier prior to mixing with the second stream of hydrogen gas. In a further embodiment, a turbine is additionally present through which hydrogen gas from the hydrogen gas storage facility flows; the turbine converts hydrogen gas to mechanical energy, and if connected to a generator, to electrical energy. In a still further embodiment, a hydrogen liquefier is additionally present. In an embodiment, a portion of the mixed stream of hydrogen gas that flows to the hydrogen gas user is diverted to a hydrogen gas liquefier for liquification thereof.

The present disclosure also relates to a process for compensating for a deviation in the production output of the first stream of hydrogen gas electrolyzer which comprises adjusting the flow of the second stream of hydrogen gas from non-electrolytic sources in said system for maintaining the gas flow of the mixed stream of hydrogen gas at the predetermined rate in the first conduit to the hydrogen gas user. In a further embodiment, the present disclosures relates to the above-identified process where there is a decrease or curtail in electricity flow to the electrolyzer relative to a baseline and/or a decrease in hydrogen gas production therefrom, whereby said system maintains the mixed stream of hydrogen gas flow in the first conduit at a predetermined rate by an increase in the output of the second stream of hydrogen gas from the non-electrolyzer, such as SMR, at a rate sufficient for maintaining at the predetermined rate the mixed stream of hydrogen gas flowing in the first conduit to the hydrogen gas user. In a further embodiment, the present disclosure relates to the above process where there is a decrease or curtail in electricity flow to the electrolyzer relative to a baseline and/or decrease in hydrogen gas production therefrom, whereby said system maintains the mixed stream of hydrogen gas flow in the first conduit at a predetermined rate by a release of a third stream of hydrogen gas from a hydrogen gas storage facility into a fourth conduit that connects the hydrogen gas storage facility to the first conduit at a rate sufficient for maintaining the rate of flow of the mixed stream of hydrogen gas to the hydrogen gas user in the first conduit at the predetermined rate. In another embodiment, the present disclosure relates to the above process where the consumption of electricity by the electrolyzer is above the baseline; the system maintains the mixed stream of hydrogen gas flow at the predetermined rate to the hydrogen gas user by decreasing the output of the second stream of hydrogen gas from the non-electrolyzer, such as SMR or decreasing the output of the first stream of hydrogen gas from the electrolyzer, and/or transporting a portion of the mixed stream of hydrogen gas produced by the system to a hydrogen gas storage facility that flows through a fourth conduit that connects the hydrogen gas storage facility to the first conduit or a combination of both at a rate sufficient for maintaining the rate of flow of the mixed stream of hydrogen gas to the hydrogen gas user in the first conduit at the predetermined rate. In a further embodiment, the process additionally comprises monitoring the pressure of the mixed stream of hydrogen gas flowing in the first conduit to the hydrogen gas user such that if the pressure of the mixed stream of hydrogen gas is lower than a predetermined value (a baseline), then either increasing the production of the first stream of hydrogen gas from the electrolyzer or increasing the production of the second stream of hydrogen gas from the non-electrolyzer or transporting hydrogen gas from the hydrogen gas storage facility to the first conduit or a combination of both at a rate sufficient to maintain the flow of the mixed stream of hydrogen gas to the hydrogen gas user at the predetermined rate; or if the pressure of the mixed stream of hydrogen gas is more than the predetermined value, then decreasing the production of the first stream of hydrogen gas from the electrolyzer and/or decreasing the production of the second stream of hydrogen gas from the non-electrolyzer, such as SMR, or diverting a portion of the mixed stream of hydrogen gas to a hydrogen gas storage facility or a combination thereof. In a still further embodiment, the process additionally comprises controlling the flow of the amount of the mixed stream of hydrogen gas that flows to the hydrogen gas user by passing said mixture through a first valve which controls the amount of the mixed stream of hydrogen gas that flows therethrough. In a further embodiment, the process additionally comprises compressing the first stream of hydrogen gas produced from the electrolyzer in a second compressor prior to mixing with the second stream of hydrogen gas. In an embodiment, the process additionally comprises drying the first stream of hydrogen gas in a drier prior to mixing with the second stream. In another embodiment, the process additionally comprises storing a portion of the mixed stream of hydrogen gas in a hydrogen gas storage facility. In a still further embodiment, the process additionally comprises monitoring the pressure of the mixed stream of hydrogen gas that flows to the hydrogen gas user, and if the pressure rises above some predetermined value of pressure, diverting the flow of the mixed stream of hydrogen gas to a hydrogen gas storage facility until the pressure of the mixed stream of hydrogen gas flowing to the hydrogen gas user is lowered to the predetermined value, or if the pressure of the mixed stream of hydrogen gas is below the predetermined value of pressure, releasing a third stream of hydrogen gas from the hydrogen gas storage facility to flow into the first conduit leading to the hydrogen gas user until the pressure in the hydrogen gas mixture rises to the predetermined value. In an embodiment, the process additionally comprises diverting some of the mixed stream of hydrogen gas to a turbine. In a further embodiment, the process comprises additionally diverting the mixed stream of hydrogen gas to a hydrogen gas liquefier to liquefy the hydrogen gas. Another embodiment comprises additionally storing the liquified hydrogen gas.

### BRIEF DESCRIPTION OF THE DRAWINGS

The objects, features and advantages will become apparent to one ordinary skill in the art, in view of the following detailed description taken in combination with the attached drawings. In the drawings, the dashed lines refer to a communications link, i.e., dashed lines indicate control signal carrying connections, solid lines indicate stream of hydrogen gas connections, such as a pipe or conduit, the double dashed line refers to an electric power grid, and the geometric shapes, such as squares, ovals, trapezoids, hexagons, circles or hourglass shape or any geometric shape that is not a dashed or solid line refers to a component part of the system.

FIG. 1 is a schematic of a first embodiment of the system for producing hydrogen gas which comprises, in part, an electrolyzer and non-electrolyzer, such as SMR, for independently producing hydrogen gas; a controller having a communications link with the electrolyzer; a communications link of the electrolyzer with the non-electrolyzer, such as SMR; a pressure controller and compressor in communications link with the pressure controller; a second compressor for compressing the hydrogen gas produced by the electrolyzer, and a hydrogen gas storage facility for any excess hydrogen gas produced by the system.

FIG. 2 is a schematic of a variation of the system in FIG. 1 without the hydrogen gas storage facility.

FIG. 3 is a schematic of a variation of the system in FIG. 1 without the hydrogen gas storage facility or second compressor.

FIG. 4 is a schematic of a variation of the system of FIG. 1 additionally comprising a turbine.

FIG. 5 is a schematic of a variation of the system of FIG. 1 additionally comprising a liquid hydrogen liquefier and a reservoir to store the liquid hydrogen.

FIG. 6 is a process flow and a block diagram of an embodiment illustrating the method and system for hydrogen gas production in accordance with an aspect of the present disclosure.

### DETAILED DESCRIPTION

The ensuing detailed description provides preferred exemplary embodiments only, and is not intended to limit the scope, applicability, or configuration of the invention. Rather, the ensuing detailed description of the exemplary embodiments will provide those skilled in the art with an enabling description for implementing the exemplary embodiments of the invention, it being understood that various changes may be made in the function and arrangement of elements without departing from the scope of the invention as defined by the claims.

Those of skill in the art also understand that the terminology used for describing the various embodiments does not limit the scope or breadth of the disclosure. In interpreting the specification and appended claims, all terms should be interpreted in the broadest possible manner consistent with the context of each term. All technical and scientific terms used in the specification and appended claims have the same meaning as commonly understood by one of ordinary skill in the art to which this invention belongs, unless defined otherwise.

The articles “a” and “an”, as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The term “and/or” placed between a first entity and a second entity includes any of the meanings of (1) only the first entity, (2) only the second entity, and (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B and not C, (5) A and C and not B, (6) B and C and not A, and (7) A and B and C.

As used herein, the term “or” is not meant to be exclusive; rather the term is inclusive, meaning either or both.

An “electrolyzer”, as used herein, is an apparatus that converts electrical energy into chemical energy in the form of hydrogen gas. In an embodiment, the electrolyzer is a water electrolyzer, which produces oxygen and hydrogen gas from water and electricity from the power grid.

As used herein, electrolysis is a process that converts electrical energy into chemical energy in the form of hydrogen gas. Electrolysis reactions include but are not limited to processes of converting ammonia or water to form hydrogen gas using electrical energy, either using DC current (a battery) or AC current, such as by electricity.

A “non-electrolytic process”, as used herein, is a chemical process that produces hydrogen gas by means other than by electrolysis. For example, a steam methane reforming process is an example of a non-electrolytic process since hydrogen gas is formed by a process which is not electrolysis.

As used herein, a “SMR” or steam methane reformer is a chemical device in which a hydrocarbon containing feed, such as natural gas, the largest component of which is methane, is combined with steam to produce hydrogen gas. Steam methane reformers can utilize a variety of feed stocks, for instance, refinery off-gases, natural gas, butane, light naphtha and naphtha and the like. In the process in the SMR, the hydrocarbon feed is introduced into reformer tubes located within a fired furnace of the reformer. The reformer tubes contain a catalyst that catalyzes a steam methane reforming reaction in which the hydrocarbon feed, such as methane, and steam are reacted to form carbon monoxide and hydrogen, as indicated below:

CH₄+H₂O [symbol] 3H₂+CO

This is an endothermic reaction. Typically, part of the hydrocarbon containing feed is combined with steam and introduced into the reformer tubes and another part of the feed is fed to burners firing into the furnace section to support the steam methane reforming reaction. In typical steam methane reformers, the steam to carbon molar ratio is set at about 2.8.

The heated product stream of the steam methane reforming reaction is cooled and subjected to a high temperature shift reaction to react the carbon monoxide with residual steam to produce additional hydrogen, as follows:

CO+H₂O [symbol] CO₂+H₂

The resulting shifted stream is then introduced into a pressure swing adsorption unit in which the hydrogen gas is separated therefrom to form a product stream and a stream of tail gas that can be introduced into the burners to help fire the furnace section of the steam methane reformer.

Steam methane reformers also have a convective section connected to the furnace section in which flue gas is routed to a heat boiler feed water and produce steam. The boiler feed water after deaeration and heating to near its boiling temperature is then introduced into a steam drum. Water from the steam drum is partially vaporized in the boiler and returned to the steam drum as low-quality steam. Steam from the steam drum is introduced into a superheater in the convective section to form superheated steam. The superheated steam is combined with the hydrocarbon feed to produce the reactant stream for the steam methane reformer and part of the superheated steam can be advantageously exported at a profit. The flue gas is discharged from the convective section through a stack.

The term “non-electrolyzer” refer to a source of producing hydrogen gas other than by electrolysis. SMR is an example of a non-electrolyzer.

As used herein, the term “communications link” refers to two or more components being capable of communicating with one other via a wire or wirelessly. Wired network connections may be of any type and may include, but not limited to, Ethernet, HomePNA, ISDN, Prime or G3 PLC, PON and the like. Wireless communication may include microwave communication, optical line of sight communication, radio-frequency communication, or any other suitable form of communication. The wireless communication may be of any type such as, but not limited to GPRS, Wi-Fi WiMAX, EVDO, LIE and the like. For example, in one embodiment, a computerized signal is transmitted through network lines, wirelessly, using power line communications or through another similar communication means to the receiver component, either with information or instructions to perform a function. In an aspect of the present disclosure, one component of the system transmits an electronic signal relaying information or instructions to the receiver component which may be in a machine useable form.

As used herein, a “conduit” is a pipe or pipe segment, pipeline or a tube or other passageway through Which hydrogen gas flows. The terms “conduit”, “pipe”, “pipe segment”, “pipeline” “tube” and the like are synonymous and are used interchangeably.

As used herein, the term “hydrogen gas user” is a recipient or customer for the hydrogen gas produced by the hydrogen gas producers, such as by SMR or electrolyzer. It includes, for example, but is not limited to, the use of hydrogen gas by the user in chemical plants, refineries, fuel cells, fuel for vehicles, electrical and thermal generators, compressors, and other transmission apparatus or hydrogen storage facilities. As used herein the term “hydrogen gas user” and “customer” are synonymous and are used interchangeably.

The terms “upstream” and “downstream” are relative terms in a process, such as the flow of hydrogen in a conduit. “Upstream”, as used herein, refers to an earlier point or position in the conduit or process relative to a position or point in the conduit or process and “downstream” refers to a later position or point in a conduit or process. If one considers the flow of hydrogen gas in a conduit like the flow of a river or stream, the term “upstream” refers to moving or situated in the opposite direction from that in which a stream or river flows and “downstream” refers to moving or situated in the direction in which a stream or river flows.

The term “grid services” refers to services provided by an electric power grid, which includes regulating the power in the system by supplying a controllable reactive power from the power supply to the system and producing an amount of hydrogen gas based upon the supplied controllable reactive power to the system. It also includes monitoring the load, voltage, and frequency of the electric power grid, and adjusting the electricity consumption to keep the grid stable. Finally, grid service also includes monitoring the amount of hydrogen gas produced in the system.

The term “baseline”, when referring to the flow of electricity to the electrolyzer refers to a predetermined but constant level of the flow of electricity to the electrolyzer that would generate a predetermined rate of flow of hydrogen gas to the hydrogen gas user if the electrolyzer were the only means for producing hydrogen gas in the system. However, as discussed above, there are fluctuations in the flow of electricity to the electrolyzer. For example, during the working day, there is more of a demand for electricity, and thus the there is less of a supply of electricity flowing from the power grid to the electrolyzer. In this case, the flow of electricity to the electrolyzer is below the baseline. On the other hand, at night, there is a lower demand of electricity, more electricity is available to flow to the electrolyzer, and thus, the flow of electricity is above the baseline.

Furthermore, the described features, structures, or characteristics of the disclosure may be combined in any suitable manner in one or more embodiments. In the following description, numerous specific details are provided. One skilled in the relevant art will recognize, however, that the subject matter of the present application may be practiced without one or more of the specific details, or with other methods, components, materials, and so forth. In other instances, well-known structures, materials, or operations are not shown or described in detail to avoid obscuring aspects of the disclosure.

In an embodiment, the present disclosure relates to a system for producing hydrogen gas which utilizes at least two hydrogen gas producers. At least one of the hydrogen gas producers produces hydrogen gas by a reaction other than by electrolysis. In an embodiment, at least one of the hydrogen gas producers is a SMR. In one embodiment, one of the hydrogen gas producers is an electrolyzer, and a second hydrogen gas producer is SMR. The hydrogen gas producers are connected to the system in parallel, producing two separate streams of hydrogen gas that eventually mix in a conduit that flows to the hydrogen gas user. The various hydrogen gas producers are in communications link with one another, and one of the hydrogen gas producers can transmit a signal to the other hydrogen gas producer to increase or decrease the production of hydrogen gas produced by the other hydrogen gas producer.

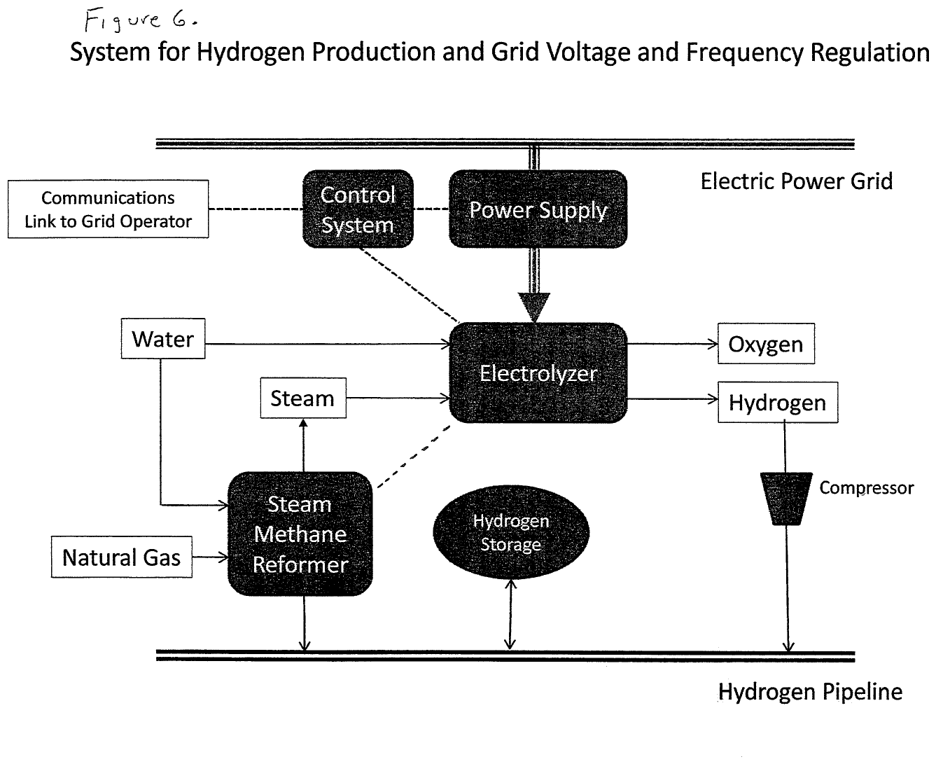

Referring to FIG. 6, in an embodiment, hydrogen gas flows in a first conduit to a hydrogen gas user (not shown) at the terminal end of the first conduit. The hydrogen gas that flows in the first conduit is produced by at least two different processes. The first hydrogen gas production process utilizes an electrolyzer in which electrolysis of water takes place utilizing electricity to produce oxygen and hydrogen as gases, and the hydrogen gas so produced is a first hydrogen gas stream that flows into a second conduit which eventually flows into a first conduit (hydrogen pipeline) through which hydrogen gas flows to the hydrogen gas user. In an embodiment, the electrolyzer includes the necessary auxiliary power supply equipment to deliver electricity at the required specific parameters for its operational use to convert water to hydrogen and oxygen gases.

The second hydrogen gas process produces hydrogen by a non-electrolytic process. In an embodiment, the second hydrogen gas process is a steam methane reforming process.

The electrolyzer is electrically coupled to a power supply, which obtains its power from the electric power grid. Moreover, the electrolyzer is electrically coupled to a grid operator who communicates through a control system which adjusts the electric energy consumption and hydrogen gas production flow rate of the electrolyzer. The electrolyzer, in turn, has a communications link to the non-electrolytic source of hydrogen gas, such as a steam methane reformer.

The grid operator goal is to balance the supply/demand of the electrical power distributed by the electrical grid. Usually, the grid operator engages with the customers that consumes electricity to adjust the electricity consumption to keep the grid stable. Generally, there is a certain agreement between the grid operator and its customer (for example, the owner of the electrolyzer) to adjust the electricity consumption as part of a so-called grid service. An electrolyzer can be used as a variable controllable load that can be reduced or increased when other loads increase or decrease to maintain the total balance and frequency of the power grid stable. Electrolyzers acting as demand response devices can respond sufficiently fast and for a long enough duration to participate in energy management on the utility scale and at end user facilities. The grid operator is interested in the amount of electricity that is consumed by a particular consumer, during a certain time of the day, when it could be included in a type of ancillary service that system operators obtain to maintain generation and load balance under normal and contingency conditions. Markets set prices for these services and determine their value. The adjustments of the electricity consumption for the electrolyzer are through a communications link directly from the grid operator to the electrolyzer. For example, the grid operator may send a signal to the electrolyzer. The electrolyzer owner adjusts the hydrogen gas production to respond to the grid operator requirements. However, by doing so, hydrogen gas production fluctuates. To compensate for this fluctuation and to keep the hydrogen gas flow rate at the level demanded by the customer at a prescribed flow rate, an additional source of hydrogen gas production is used. This additional source of hydrogen gas is the non-electrolyzer, such as an SMR, as shown in FIG. 6, which is in communications link with the electrolyzer. For example, the electrolyzer is programmed to produce a certain amount of hydrogen gas therefrom. When electricity demand is high, such as during the day, the grid operator communicates to the electrolyzer that less electricity is supplied to the electrolyzer. As a result, less hydrogen gas is produced by the electrolyzer. If this amount of hydrogen gas produced is below the prescribed level (baseline), it generates a signal to the non-electrolytic source of hydrogen gas, such as a steam methane reformer, to produce additional hydrogen gas to compensate for the decrease in the amount of hydrogen gas produced by the electrolyzer so that the amount of hydrogen gas produced by the system and provided to the consumer is relatively constant. On the other hand, when electricity demand is low, such as at night, the predetermined amount of hydrogen gas produced by the electrolyzer can be achieved, so that it communicates to the non-electrolytic source of hydrogen gas, such as a steam methane reformer, to produce less hydrogen gas so that the amount of hydrogen gas produced by this source is decreased so that the overall production of hydrogen gas from the system is at the prescribed level. In this way, the rate of hydrogen gas produced by the system is controlled to produce hydrogen gas at a predetermined level. Therefore, a decrease on the power or voltage in the electric power grid would not have such a dramatic effect since there is a second means for producing hydrogen gas which is not as dependent on the electric power grid as an electrolyzer. Thus, the grid operator communicating to the electrolyzer by generating a transmission indicating whether there is a decrease or increase in the electricity flowing to the electrolysis, and the electrolyzer providing communication to the non-electrolyzer, such as steam methane reformer, and the increase or decrease or no change in output of hydrogen gas production from the non-electrolyzer in response to this communication provides a means for controlling and maintaining a continuous flow of hydrogen gas to the hydrogen gas user and a means for compensating in fluctuations of hydrogen production from the electrolyzer

The hydrogen gas produced by the steam methane reformer produces a second hydrogen gas stream that flows into a third conduit that leads to the first conduit and the second stream of hydrogen mixes with the first stream of hydrogen gas that is produced by the electrolyzer in the first conduit to form a mixed stream of hydrogen gas.

The steam methane reformer is in communications link with the electrolyzer. If additional hydrogen gas is required to be produced, the electrolyzer communicates to the non-electrolytic source, such as by transmitting a signal to the steam methane reformer to produce additional hydrogen gas. The steam methane reformer not only produces hydrogen, but also produces steam (water vapor) which, in an embodiment, may be fed into the electrolyzer, as shown in FIG. 6, and which undergoes electrolysis therein, as described hereinabove. In addition, in an embodiment, the present system comprises a first compressor that controls the pressure of the mixed hydrogen gas stream that flows to the hydrogen gas user to increase the pressure of the mixed hydrogen gas stream. If additional pressure is required to flow to the hydrogen gas user, the compressor increases the pressure of hydrogen gas that flows in the conduit to the hydrogen gas user. In an embodiment, the system also comprises a hydrogen gas storage facility (identified as hydrogen storage in FIG. 6) for storing hydrogen gas when the pressure in the first conduit that flows to the hydrogen user is above a predetermined pressure. When the pressure in the conduit falls below the third predetermined pressure, the hydrogen gas in the hydrogen gas storage facility is released into the first conduit that flows to the hydrogen gas user to increase the pressure therein to the predetermined pressure.

The present disclosure will be described in more detail by reference to the other figures.

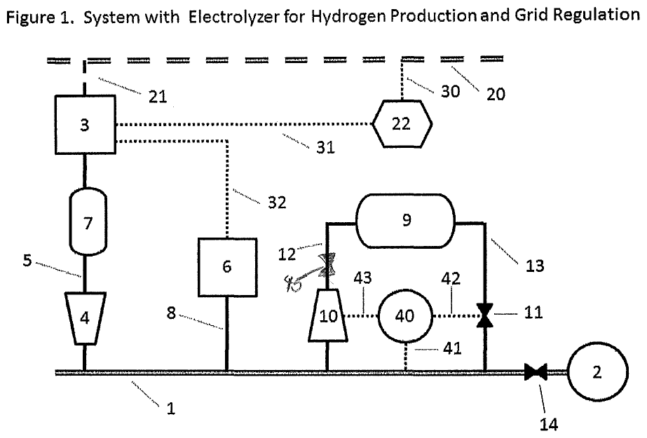

With reference to FIG. 1, pipeline 1 supplies hydrogen gas to customer 2 via valve 14. Valve 14 is under the control of customer 2 to receive a flow rate of hydrogen gas flow from pipeline 1 matching consumption of hydrogen gas by customer 2. Hydrogen gas is produced by two different sources, electrolyzer 3 and a non-electrolytic source, such as steam methane reformer (SMR) 6. SMR 6 operates at a pressure such that hydrogen gas can be delivered directly to pipeline 1 via pipe segment 8. Hydrogen gas produced by electrolyzer 3 flows to pipeline 1 via pipe segment 5. Depending upon the operating pressure of electrolyzer 3, it may be necessary to compress hydrogen gas from electrolyzer 3 to enable hydrogen gas produced therefrom to enter pipeline 1 in which case compressor 4 is inserted between electrolyzer 3 and pipeline 1. Certain types of electrolyzers, for example, those employing a polymer electrolyte membrane (PEM) will produce hydrogen gas containing water. This water can be removed prior to the hydrogen gas from electrolyzer 3 entering pipeline 1 by inserting a drying unit 7 between electrolyzer 3 and pipeline 1. The drying unit 7 can be of the adsorption type using one or more adsorbent materials to capture the water. The hydrogen gas generated from the electrolyzer 3 that flows in pipeline 5 to pipeline 1 and the hydrogen gas generated from SMR 6 that flows in pipeline 8 to pipeline 1 mix in pipeline 1 to form a mixed stream of hydrogen gas.

Electrolyzer 3 receives electrical energy via cable 21 from the utility power grid 20. Grid system operator 22 monitors load, voltage, and frequency of utility power grid 20, collecting data which is transmitted to grid system operator 22 via communications link 30. Utility grid system operator 22 generates a control signal that is sent to electrolyzer 3 via communications link 31. This control signal adjusts the electrical energy consumption and hydrogen gas production flow rate of electrolyzer 3 to regulate load, voltage, and frequency of utility power grid 20. Electrolyzer 3, in turn, generates a control signal that is transmitted via communication link 32 to SMR 6. This control signal adjusts the hydrogen gas production flow rate of SMR 6 with the purpose of compensating for changes in the hydrogen gas production capacity flow rate of electrolyzer 3 resulting from the use of electrolyzer 3 to control the load, voltage, and frequency of utility power grid 20.

Pressure controller 40 monitors the pressure of hydrogen gas in pipeline 1. Data is transmitted from pressure transducers located on the pipeline (not shown) to pressure controller 40 via communications link 41. If the pressure of pipeline 1 rises above some predetermined value, pressure controller 40 generates a control signal which is transmitted to compressor 10 via communications link 43, instructing compressor 10 to cause hydrogen gas to flow from pipeline 1 into hydrogen gas storage facility 9 via pipe segment 12 and thereby lower the pressure of hydrogen gas in pipeline 1. In addition, pressure controller 40 generates a signal to valve 11 through communications link 42 to close valve 11 so that the hydrogen gas in hydrogen gas storage facility 9 does not flow into conduit 1. In an embodiment, when compressor 10 receives the signal from communications link 43 when the pressure of pipeline 1 rises above the predetermined value, compressor 10 is turned on, allowing some of the mixed hydrogen gas to enter pipe segment 12 to flow to hydrogen gas storage facility 9. On the other hand, if the pressure of pipeline 1 falls below the predetermined value, then pressure controller 40 generates a signal to valve 11 to open, thereby allowing hydrogen gas from hydrogen gas storage facility 9 to flow into conduit 1 and to turn off the compressor 10 so that the mixed stream of hydrogen gas does not enter pipe segment 12. Generally, when valve 11 is open, compressor 10 is turned off; likewise, when compressor 10 is operating, valve 11 is closed. The actions of pressure controller 40 are intended to ensure that the pressure of pipeline 1 is high enough to permit customer 2 to obtain the required flow rate of hydrogen gas by adjusting valve 14.

In an embodiment, conduit 12 contains a valve 45 which may be located between conduit 1 and compressor 10 (not shown) or between compressor 10 and hydrogen gas storage facility 9. When the compressor 10 is turned on (when the pressure of pipeline 1 rises above the predetermined level and compressor 10 receives a signal from pressure controller 40 to turn on), valve 45 is opened. On the other hand, when compressor 10 is turned off (when the pressure in pipeline 1 falls below the predetermined level and compressor 10 receives a signal from pressure controller 40 to turn off), valve 45 is closed. The opening and closing of valve 45 are controlled by a communication link either between valve 45 and compressor 10 (not shown) or between valve 45 and pressure controller 40 (not shown), wherein a signal is generated through the communications link to valve 45, instructing it to either close or open.

Hydrogen gas storage facility 9 can be any fabricated pressure vessel or underground formation, for example, a solution mined cavern in a salt formation, suitable for storage of hydrogen gas at elevated pressure. In an embodiment, the hydrogen gas storage facility is never ‘empty’ in the absolute sense of having nothing in it. Usually, a gas storage facility is considered ‘empty’ when the gas pressure in the storage volume is lower than a certain value, usually a value lower than the delivery pressure specific to hydrogen gas pipeline 1. In such a situation, the hydrogen gas cannot flow into pipeline 1 via pipe segment 13. If this condition is met (the gas cannot be withdrawn from the hydrogen gas storage facility 9, and the electrolyzer has no constraints from the grid operator), all additional hydrogen gas that is not taken by customer 2 can be stored until the storage facility 9 reaches a maximum allowable pressure. This is the default mode of operation. At the other extreme case, if the customer 2 does not take the hydrogen gas (e.g., they are shut down for a certain reason, maintenance etc.), then valve 14 is closed and at the same time the hydrogen gas storage facility is at maximum allowable pressure, then both hydrogen gas sources (e.g., SMR 6 and electrolyzer 3) are shut down, because the hydrogen gas product cannot be consumed. When the customer comes back online, the hydrogen gas can be delivered from the hydrogen gas generation sources (e.g., SMR 6 and electrolyzer 3) in such a way that first the electrolytic hydrogen gas is generated when power is available from the grid operator 22, and the overall hydrogen gas flow rate to the customer is met by producing the additional amount of hydrogen gas needed from both electrolyzer 3 and SMR 6. Typically, these pipeline systems that contains hydrogen gas generation, compressors, and storage facilities are operated remotely through complex remote centers. Decisions can be made based on the supply-demand requirements of customer 2.

In an embodiment, hydrogen pipeline 1 operates in the range of 100 to 500 psia, while hydrogen gas storage facility 9 operates at pressures between 500 and 3,000 psia.

In an embodiment, there is a communications link between hydrogen gas storage facility 9 and electrolyzer 3 (not shown). In hydrogen gas storage facility 9, there is a monitor that provides the amount of hydrogen gas stored in the hydrogen gas storage facility. The amount of hydrogen gas stored is usually at a predetermined level. However, if the pressure of hydrogen gas stored is below that predetermined level, hydrogen gas storage facility 9 would generate a transmission to electrolyzer 3, which, in turn, would either produce more hydrogen gas or it would generate a signal to SMR 6 to produce more hydrogen gas. This would cause the pressure in pipeline 1 to rise above the predetermined level pressure. As a result, controller 40 would generate a control signal which is transmitted to compressor 10 via communications link 43 instructing compressor 10 to cause hydrogen gas to flow from pipeline 1 into hydrogen gas storage facility 9 via pipe segment 12 and thereby lower the pressure of pipeline 1 and store the hydrogen gas in hydrogen gas storage facility 9. This process would continue until the amount of hydrogen gas in the hydrogen gas storage facility reaches the predetermined level.

The present system compensates for a fluctuation in the electricity output from the power grid to the electrolyzer 3 by many potential responses or a combination of responses. For example, when the output of electricity to electrolyzer 3 from the electric power grid is lower than baseline, the present system can react to it and compensate for the reduction in electricity output from the electric power grid 20. The grid system operator 22 would detect this reduction in electricity output from the electric power grid 20 via communications link 30 and send a signal to electrolyzer 3 through communications link 31, which, in turn, would transmit a signal from electrolyzer 3 via communications link 32 to the non-electrolytic source of hydrogen gas, such as the SMR 6, to increase its production of hydrogen gas to a sufficient level so as to maintain the predetermined rate of mixed stream of hydrogen gas flowing to the hydrogen gas user 2. Alternatively, or if sufficient hydrogen gas is not produced from the combination of the action of electrolyzer 3 and the non-electrolyzer source, such as SMR 6, monitor 40 would detect a decrease in the pressure in the mixed stream of hydrogen gas flowing in pipeline 1 and would send a signal through communications link 43 to close compressor 10 and through communications link 42 to open valve 11 to allow hydrogen gas stored in the hydrogen gas storage facility 9 to flow into pipeline 1 to increase the flow of hydrogen gas to the hydrogen gas user 2 to the predetermined rate, or a combination of these steps may be used to compensate for the reduction of electricity output from the power grid. On the other hand, when there is an increase in electricity output from the electric power grid 20, grid system operator 22 would detect this increase through a signal via communications link 30 and send a signal through communications link 31 to electrolyzer 3 to reduce the hydrogen gas production output, and electrolyzer 3 would, in turn, send a signal via communications link 32 to the non-electrolytic source for producing hydrogen gas, such as SMR 6, to reduce the hydrogen gas output therefrom. so that the amount of hydrogen gas produced by electrolyzer 3 and the non-electrolytic source, such as SMR 6 is reduced. Alternatively, or if too much hydrogen gas is still being generated from electrolyzer 3 and SMR 6, monitor 40 would detect an increase in the pressure in the mixed stream of hydrogen gas flowing in pipeline 1 and would transmit a signal through communications link 42 to valve 11 to close the valve and would transmit a signal to compressor 10 to permit a portion of the mixed stream of hydrogen gas in pipeline 1 to be diverted into pipeline 12 and flow to the hydrogen gas storage facility 9 to decrease the flow of the mixed stream of hydrogen gas in conduit 1 to the hydrogen gas user to the predetermined rate, or a combination of these streps may be effected to compensate for the increase of electricity from the electric power grid 20.

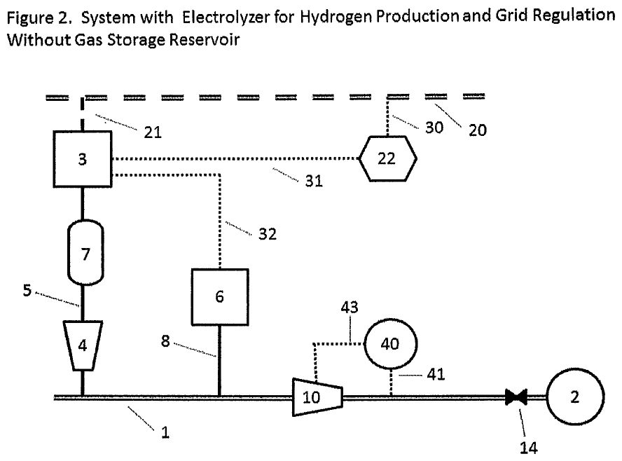

FIG. 2 shows an alternative configuration for the system of the present disclosure that does not utilize a hydrogen gas storage facility. As in FIG. 1, pipeline 1 supplies hydrogen gas to customer 2 via valve 14. Valve 14 is under the control of customer 2 to receive a flow rate of hydrogen gas flow from pipeline 1 matching consumption of hydrogen gas by customer 2. Hydrogen gas is produced by two different sources, electrolyzer 3 and steam methane reformer (SMR) 6. SMR 6 operates at a pressure such that hydrogen gas can be delivered directly to pipeline 1 via pipe segment 8. Hydrogen gas produced by electrolyzer 3 flows to pipeline 1 via pipe segment 5. Depending upon the operating pressure of electrolyzer 3, it may be necessary to compress hydrogen gas from electrolyzer 3 to enable said hydrogen gas to enter pipeline 1 in which case compressor 4 is inserted between electrolyzer 3 and pipeline 1. Certain types of electrolyzers, for example those employing a polymer electrolyte membrane (PEM) will produce hydrogen gas containing water. This water can be removed prior to the hydrogen gas produced from electrolyzer 3 entering pipeline 1 by inserting drying unit 7 between electrolyzer 3 and pipeline 1. The drying unit 7 can be of the adsorption type using one or more adsorbent materials to capture the water.

Electrolyzer 3 receives electrical energy via cable 21 from the utility power grid 20. Grid system operator 22 monitors load, voltage, and frequency of utility power grid 20, collecting data which is transmitted to grid system operator 22 via communications link 30. Utility grid system operator 22 generates a control signal that is sent to electrolyzer 3 via communications link 31. This control signal adjusts the electrical energy consumption and hydrogen gas production flow rate of electrolyzer 3 to regulate load, voltage, and frequency of utility power grid 20. Electrolyzer 3, in turn, generates a control signal that is transmitted via communication link 32 to SMR 6. This control signal adjusts the hydrogen gas production flow rate of SMR 6 with the purpose of compensating for changes in the hydrogen gas production capacity flow rate of electrolyzer 3 resulting from the use of electrolyzer 3 to control the load, voltage, and frequency of utility power grid 20.

Compressor 10 is inserted into pipeline 1 sufficiently far upstream of valve 14 to modulate the hydrogen gas pressure to the predetermined value. In this way the volume of pipeline 1 between compressor 10 and valve 14 acts as a hydrogen gas storage facility, in that the pressure in the pipeline 1 between these two positions can be increased if the pressure therein is below the predetermined value or decreased if the pressure therein is above the predetermined value. Pressure controller 40 generates a control signal that is communicated to compressor 10 via communicate link 43. In this way, the control signal adjusts the operating rate of compressor 10 to maintain the pressure of pipeline 1 between compressor 10 and valve 14 to a predetermined level, thus utilizing the volumetric capacity of pipeline 1 downstream of compressor 10 for hydrogen gas storage.

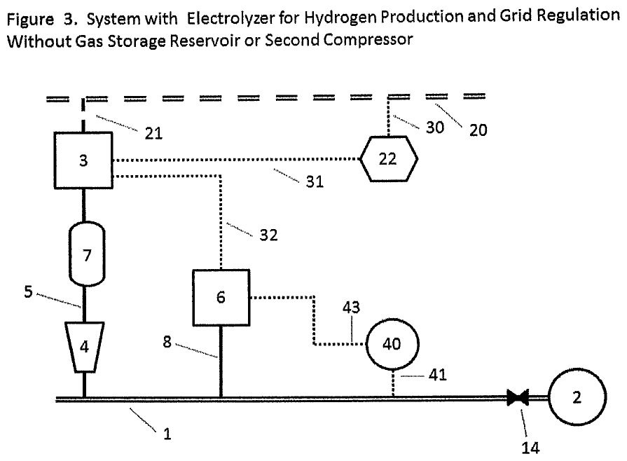

FIG. 3 shows an alternative configuration for the system of the present disclosure. As in FIG. 1, pipeline 1 supplies hydrogen gas to customer 2 via valve 14. Valve 14 is under the control of customer 2 to receive a flow rate of hydrogen gas flow from pipeline 1 matching consumption of hydrogen gas by customer 2. Hydrogen gas is produced by two different sources, electrolyzer 3 and steam methane reformer (SMR) 6. SMR 6 operates at a pressure such that hydrogen gas can be delivered directly to pipeline 1 via pipe segment 8. Hydrogen gas produced by electrolyzer 3 flows to pipeline 1 via pipe segment 5. Depending upon the operating pressure of electrolyzer 3, it may be necessary to compress hydrogen gas from electrolyzer 3 to enable said hydrogen gas to enter pipeline 1 in which case compressor 4 is inserted between electrolyzer 3 and pipeline 1. Certain types of electrolyzers, for example, those employing a polymer electrolyte membrane (PEM) will produce hydrogen gas containing water. This water can be removed prior to the hydrogen gas produced by electrolyzer 3 entering pipeline 1 by inserting drying unit 7 between electrolyzer 3 and pipeline 1. The drying unit 7 can be of the adsorption type using one or more adsorbent materials to capture the water.

Electrolyzer 3 receives electrical energy via cable 21 from the utility power grid 20. Grid system operator 22 monitors load, voltage, and frequency of utility power grid 20, collecting data which is transmitted to grid system operator 22 via communications link 30. Utility grid system operator 22 generates a control signal that is sent to electrolyzer 3 via communications link 31. This control signal adjusts the electrical energy consumption and hydrogen gas production flow rate of electrolyzer 3 to regulate load, voltage, and frequency of utility power grid 20. Electrolyzer 3, in turn, generates a control signal that is transmitted via communication link 32 to SMR 6. This control signal adjusts the hydrogen gas production flow rate of SMR 6 with the purpose of compensating for changes in the hydrogen gas production capacity flow rate of electrolyzer 3 resulting from the use of electrolyzer 3 to control the load, voltage, and frequency of utility power grid 20.

In FIG. 3, there is no hydrogen gas storage facility or a second compressor. In this case, pressure controller 40 generates a control signal that is communicated to SMR 6 via communication link 43. The control signal adjusts the operating rate of SMR 6 to maintain the pressure of pipeline 1 above a predetermined level. For example, if the hydrogen gas pressure in pipeline 1 is too low, as detected by monitor 40, then monitor 40 generates a signal to SMR 6 via communication link 43 to produce additional hydrogen gas above a predetermined level, which additional hydrogen gas above the predetermined level flows into pipe segment 8 and into pipeline 1. This results in an increase in hydrogen gas pressure in pipeline 1, thereby increasing the hydrogen gas pressure in pipeline 1, as detected by monitor 40. SMR 6 produces additional hydrogen gas until the predetermined pressure in pipeline 1 is reached, as detected by monitor 40, which in turn, transmits a signal via communication link 43 to SMR 6 to maintain the production of hydrogen gas at this level until there is another change in the pressure of the mixed stream of hydrogen gas flowing in pipeline 1 above or below the predetermined level. On the other hand, if the hydrogen gas pressure in pipeline 1 is too high, as detected by monitor 40, then monitor 40 generates a signal to SMR 6 via communication link 43 to reduce the production of hydrogen gas, which reduces the amount of hydrogen gas that flows into pipe segment 8 and into pipeline 1. This results in a decrease in hydrogen gas pressure in pipeline 1, thereby decreasing the hydrogen gas pressure in pipeline 1, as detected by monitor 40. SMR 6 reduces the amount of hydrogen gas produced until the predetermined pressure in pipeline 1 is reached, as detected by monitor 40, which in turn, transmits a signal via communication link 43 to SMR 6 to maintain the production of hydrogen gas at this level until there is another change in the pressure of the mixed stream of hydrogen gas flowing in pipeline 1 above or below the predetermined level.

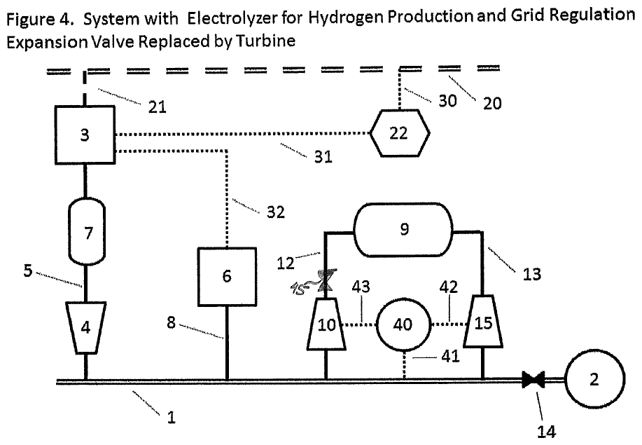

FIG. 4 shows an alternative configuration for the system of the present disclosure relative to FIG. 1. As in FIG. 1, pipeline 1 supplies hydrogen gas to customer 2 via valve 14. Valve 14 is under the control of customer 2 to receive a flow rate of hydrogen gas flow from pipeline 1 matching consumption of hydrogen gas by customer 2. Hydrogen gas is produced by two different sources, electrolyzer 3 and steam methane reformer (SMR) 6. SMR 6 operates at a pressure such that hydrogen gas can be delivered directly to pipeline 1 via pipe segment 8. Hydrogen gas produced by electrolyzer 3 flows to pipeline 1 via pipe segment 5. Depending upon the operating pressure of electrolyzer 3, it may be necessary to compress hydrogen gas from electrolyzer 3 to enable said hydrogen gas to enter pipeline 1 in which case compressor 4 is inserted between electrolyzer 3 and pipeline 1. Certain types of electrolyzers, for example those employing a polymer electrolyte membrane (PEM) will produce hydrogen gas containing water. This water can be removed prior to the hydrogen gas from electrolyzer 3 entering pipeline 1 by inserting drying unit 7 between electrolyzer 3 and pipeline 1. The drying unit 7 can be of the adsorption type using one or more adsorbent materials to capture the water.

Electrolyzer 3 receives electrical energy via cable 21 from the utility power grid 20. Grid system operator 22 monitors load, voltage, and frequency of utility power grid 20, collecting data which is transmitted to grid system operator 22 via communications link 30. Utility grid system operator 22 generates a control signal that is sent to electrolyzer 3 via communications link 31. This control signal adjusts the electrical energy consumption and hydrogen gas production flow rate of electrolyzer 3 to regulate load, voltage, and frequency of utility power grid 20. Electrolyzer 3, in turn, generates a control signal that is transmitted via communication link 32 to SMR 6. This control signal adjusts the hydrogen gas production flow rate of SMR 6 with the purpose of compensating for changes in the hydrogen gas production capacity flow rate of electrolyzer 3 resulting from the use of electrolyzer 3 to control the load, voltage, and frequency of utility power grid 20.

Pressure controller 40 monitors the pressure of hydrogen gas in pipeline 1. Data is transmitted from pressure transducers located on the pipeline (not shown) to pressure controller 40 via communications link 41. If the pressure of pipeline 1 rises above some predetermined value, pressure controller 40 generates a control signal which is transmitted to compressor 10 via communications link 43 instructing compressor 10 to cause hydrogen gas to flow from pipeline 1 into hydrogen gas storage facility 9 via pipe segment 12, thereby lowering the pressure of pipeline 1. Hydrogen gas storage facility 9 can be any fabricated pressure vessel or underground formation, for example, a solution mined cavern in a salt formation, suitable for storage of hydrogen gas at elevated pressure. In an embodiment, hydrogen gas pipeline 2 operates in the range of 100 to 500 psia, while hydrogen gas storage facility 9 operates at pressures between 500 and 3,000 psia.

The system in FIG. 4 works similar to the system illustrated in FIG. 1, except valve 11 previously shown in FIG. 1 is replaced with expansion turbine 15. This enables mechanical energy to be obtained from the expansion of the high-pressure hydrogen gas contained in hydrogen gas storage facility 9. This mechanical energy can be converted to electricity by coupling expansion turbine 15 to an electrical generator (not shown). In FIG. 4, hydrogen gas released from the hydrogen gas storage facility 9 flows through the turbine back into pipeline 1. Thus, in this embodiment, not only does the hydrogen gas user receive a constant flow of hydrogen, but also hydrogen gas is converted into mechanical energy or electrical energy if connected to a generator. In an embodiment, hydrogen gas is continually released from hydrogen gas storage facility at a rate sufficient to maintain the predetermined pressure in pipeline 1 while at the same time supplying hydrogen gas to the hydrogen gas user 2.

Thus, this system functions as explained in FIG. 1, except that the turbine 15 replaces valve 11.

In an embodiment, there is a communications link between hydrogen gas storage facility 9 and electrolyzer 3 (not shown). In hydrogen gas storage facility 9, there is a monitor that provides the amount of hydrogen gas stored in the hydrogen gas storage facility. The amount of hydrogen gas stored is usually at a predetermined level. However, if the pressure of the hydrogen gas stored is below that predetermined level, hydrogen gas storage facility 9 would generate a transmission to electrolyzer 3, which in turn would either produce more hydrogen gas, or it would generate a signal to SMR 6 to produce more hydrogen gas. This would cause the pressure in pipeline 1 to rise above the predetermined level pressure. As a result, controller 40 would generate a control signal which is transmitted to compressor 10 via communications link 43 instructing compressor 10 to cause hydrogen gas to flow from pipeline 1 into hydrogen gas storage facility 9 via pipe segment 12 and thereby lower the pressure of pipeline 1 and restore the hydrogen gas in hydrogen gas storage facility 9. This process would continue until the amount of hydrogen gas in the hydrogen gas storage facility 9 reaches the predetermined level.

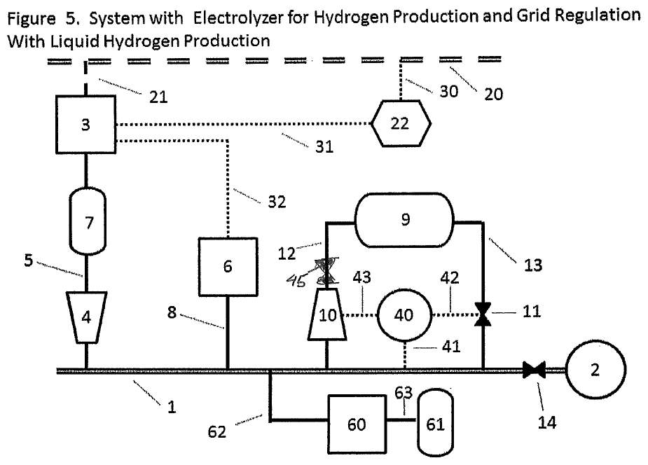

FIG. 5 is an alternative embodiment of the present disclosure. As in FIG. 1, pipeline 1 supplies hydrogen gas to customer 2 via valve 14. Valve 14 is under the control of customer 2 to receive a flow rate of hydrogen gas flow from pipeline 1 matching consumption of hydrogen gas by customer 2. Hydrogen gas is produced by two different sources, electrolyzer 3 and steam methane reformer (SMR) 6. SMR 6 operates at a pressure such that hydrogen gas can be delivered directly to pipeline 1 via pipe segment 8. Hydrogen gas produced by electrolyzer 3 flows to pipeline 1 via pipe segment 5. Depending upon the operating pressure of electrolyzer 3, it may be necessary to compress hydrogen gas from electrolyzer 3 to enable said hydrogen gas to enter pipeline 1 in which case compressor 4 is inserted between electrolyzer 3 and pipeline 1. Certain types of electrolyzers, for example those employing a polymer electrolyte membrane (PEM) will produce hydrogen containing water. This water can be removed prior to the hydrogen gas from electrolyzer 3 entering pipeline 1 by inserting drying unit 7 between electrolyzer 3 and pipeline 1. The drying unit 7 can be of the adsorption type using one or more adsorbent materials to capture the water.

Electrolyzer 3 receives electrical energy via cable 21 from the utility power grid 20. Grid system operator 22 monitors load, voltage, and frequency of utility power grid 20, collecting data which is transmitted to grid system operator 22 via communications link 30. Utility grid system operator 22 generates a control signal that is sent to electrolyzer 3 via communications link 31. This control signal adjusts the electrical energy consumption and hydrogen gas production flow rate of electrolyzer 3 to regulate load, voltage, and frequency of utility power grid 20. Electrolyzer 3 in turn generates a control signal that is transmitted via communication link 32 to SMR 6. This control signal adjusts the hydrogen gas production flow rate of SMR 6 with the purpose of compensating for changes in the hydrogen gas production capacity flow rate of electrolyzer 3 resulting from the use of electrolyzer 3 to control the load, voltage, and frequency of utility power grid 20.

Pressure controller 40 monitors the pressure of hydrogen gas in pipeline 1. Data is transmitted from pressure transducers located on the pipeline (not shown) to pressure controller 40 via communications link 41. If the pressure of pipeline 1 rises above some predetermined value, pressure controller 40 generates a control signal which is transmitted to compressor 10 via communications link 43 instructing compressor 10 to cause hydrogen gas to flow from pipeline 1 into hydrogen gas storage facility 9 via pipe segment 12, thereby lowering the pressure of hydrogen gas in pipeline 1. Hydrogen gas storage facility 9 can be any fabricated pressure vessel or underground formation, for example, a solution mined cavern in a salt formation, suitable for storage of hydrogen gas at elevated pressure. In an embodiment, hydrogen pipeline 2 operates in the range of 100 to 500 psia while hydrogen gas storage facility 9 operates at pressures between 500 and 3,000 psia. If the pressure of pipeline 2 falls below a predetermined level, pressure controller 40 generates a control signal that is communicated to valve 11 causing valve 11 to open, allowing hydrogen gas to flow from hydrogen gas storage facility 9 via pipe segment 13 into pipeline 1. Generally, when valve 11 is open, compressor 10 is turned off; likewise, when compressor 10 is operating, valve 11 is closed. The actions of pressure controller 40 are intended to ensure that the pressure of pipeline 2 is high enough to permit customer 2 to obtain the required flow rate of hydrogen by adjusting valve 14. Again, this system functions similarly to the system depicted in FIG. 1.

FIG. 5 shows the addition of a hydrogen liquefier 60 and liquid hydrogen reservoir 61 to the configuration previously shown as FIG. 1. A portion of the hydrogen gas flowing in pipeline 1 is diverted into line 62 to hydrogen liquefier 60. Liquid hydrogen gas product flows from hydrogen liquefier 60 to liquid hydrogen reservoir 61 through pipe segment 63.

In summary, the present disclosure relates to a system and process for producing a continuous flow of hydrogen gas to a hydrogen gas user which comprises providing an electrolyzer 3 which provides a first stream of hydrogen gas flowing in pipe segment 5 and providing a SMR 6 which produces a second stream of hydrogen gas flowing in pipe segment 8. The hydrogen gas pressures in each of pipe segments 5 and 8, in the normal course, are at predetermined levels, respectively. The pressure of the mixed hydrogen gases in pipeline 1 is detected by pressure controller 40, which monitors the pressure of hydrogen gas in pipeline 1 via communications link 41 at a position downstream from where the first stream of hydrogen gas and the second stream of hydrogen gas mix.

In an embodiment, there is a communications link (not shown) between hydrogen gas storage facility 9 and electrolyzer 3. In hydrogen gas storage facility 9, there is a monitor that provides the amount of hydrogen gas stored in the hydrogen gas storage facility. The amount of hydrogen gas stored is usually at a predetermined level. However, if the concentration of hydrogen gas stored is below that predetermined level, hydrogen gas storage facility hydrogen gas storage facility 9 would generate a transmission to electrolyzer 3, which in turn would either produce more hydrogen gas or it would generate a signal to SMR 6 to produce more hydrogen gas or both would occur. This would cause the pressure in pipeline 1 to rise above the predetermined level pressure. As a result, controller 40 would generate a control signal which is transmitted to compressor 10 via communications link 43 instructing compressor 10 to cause hydrogen gas to flow from pipeline 1 into hydrogen gas storage facility 9 via pipe segment 12 and thereby lower the pressure of pipeline 1 and store the hydrogen gas in hydrogen gas storage facility 9. This process would continue until the amount of hydrogen gas in the hydrogen gas storage facility 9 reaches the predetermined level.

As shown by the embodiments herein, utilizing a second hydrogen gas producer which is non-electrolytic, such as a steam methane reformer, in accordance with the present system, provides a method of maintaining a continuous flow of hydrogen gas to a hydrogen gas user. More specifically, in this system, if there is a decrease in voltage or power in the utility power grid 20, the effect may be a decrease in the output of hydrogen gas produced by electrolyzer 3, resulting in a potential decrease in the hydrogen gas pressure in pipeline 1. The grid system operator 22 transmits a signal via communication link 30 to electrolyzer 3 to increase hydrogen gas production or electrolyzer 3 may transmit a signal via communications link 32 to SMR 6 to increase hydrogen gas production or there may be a combination of both. This would result in an increase in hydrogen gas pressure in pipeline 1, which would be detected by monitor 40 in pipeline 1.

In embodiments where there is a hydrogen gas storage facility 9 for storing hydrogen gas, as in FIGS. 1,2, 4 and 5, if the pressure of pipeline 1 rises above some predetermined value, as detected by pressure controller 40, pressure controller 40 generates a signal which is transmitted to compressor 10 via communications link 43 instructing compressor 10 to cause hydrogen gas to flow from pipeline 1 into hydrogen gas storage facility 9 via pipe segment 12, and a signal to valve 11 to close, thereby lowering the hydrogen gas pressure of pipeline 1. In an embodiment, there is a valve 45 on pipe segment 12, so that when compressor 10 is activated and is open, valve 45 is also open, thereby allowing hydrogen gas to flow through pipe segment 12 to the hydrogen gas storage facility 9. This process continues until the hydrogen gas pressure in pipeline 1, as detected by pressure controller 40, is at the predetermined hydrogen gas pressure, at which time, pressure controller 40 would transmit it a signal to compressor 10 to stop diverting the mixed stream of hydrogen gas to hydrogen gas storage facility. 9. If the pressure of pipeline 1 falls below a predetermined level, pressure controller 40 generates a control signal that is communicated to valve 11 causing valve 11 to open allowing hydrogen to flow from hydrogen gas storage facility 9 via pipe segment 13 into pipeline 1 and a control system to compressor 10 to turn off and for valve 45 to close, if present, so that hydrogen gas does not flow in pipe segment 12. When valve 11 is open, compressor 10 is turned off; likewise, when compressor 10 is operating, valve 11 is closed. The actions of pressure controller 40 are intended to ensure that the pressure of pipeline 1 is high enough to permit hydrogen gas user 2 to obtain the predetermined pressure of hydrogen gas. When the pressure in pipeline 1 is lowered to the predetermined pressure, as detected by pressure controller 40, compressor 10 is turned on and valve 11 is turned off.

In embodiments where turbine 15 is present, as in FIG. 4, when the pressure of pipeline 1 rises above some predetermined value, as detected by pressure controller 40, pressure controller 40 generates a signal which is transmitted to compressor 10 via communications link 43, instructing compressor 10 to cause hydrogen to flow from pipeline 1 into hydrogen gas storage facility 9 via pipe segment 12. The high-pressure hydrogen gas is released from hydrogen gas storage facility 9 through pipe segment 13 to turbine 15, thereby lowering the hydrogen gas pressure of pipeline 1, and converting the high-pressure hydrogen gas flowing in segment 13 into mechanical energy, and if connected to a generator, into electrical energy. This process continues until the hydrogen gas pressure in pipeline 1, as detected by pressure controller 40, is at the predetermined hydrogen gas pressure, at which time, pressure controller 40 would transmit it a signal to compressor 10 to stop diverting the mixed stream of hydrogen gas to pipe segment 12.

In embodiments where the monitor 40 has a communication link to SMR 6 via communications link 43, but in the absence of compressor 10, as in FIG. 3, if the hydrogen gas pressure is below a predetermined hydrogen gas pressure, monitor 40 would transmit a signal to SMR 6, which would increase the output of hydrogen gas production of SMR 6, producing a hydrogen gas stream flowing into pipe segment 8 of increased hydrogen gas pressure. This hydrogen gas stream would flow into pipeline 1, thereby increasing the hydrogen gas pressure in pipeline 1. SMR 6 continues to produce this increase in hydrogen gas until the predetermined pressure in pipeline 1 is achieved and detected by monitor 40, which would transmit a signal to SMR 6 through communications link 43 to reduce the increased hydrogen gas output to the predetermined level.

By providing a continuous flow of hydrogen gas to the hydrogen gas user, the hydrogen gas user could be paying a higher premium relative to a system where the hydrogen gas is produced by the electrolyzer alone, where there is a variable flow of hydrogen gas. But the present system would increase the hydrogen gas sales revenue as the hydrogen gas user would be willing to pay a higher rate for hydrogen gas associated with a continuous supply.

Illustrative embodiments of the invention are described herein. While the invention is susceptible to various modifications and alternative forms, specific embodiments thereof have been shown by way of example in the drawings and are herein described in detail. It should be understood, however that the description herein of specific embodiments is not intended to limit the invention to the particular forms disclosed, but on the contrary, the invention is to cover all modifications, equivalents, and alternatives falling within the scope of the invention as defined by the appended claims.

What is claimed:

1. A system which comprises (1) an electric power grid; (2) an electrolyzer generating a first stream of hydrogen gas at a baseline rate in communication link with the electric power grid that is capable of providing grid services to transmission and distribution system operators to maintain a power transfer and distribution and providing a baseline of electricity to the electrolyzer; (3) a hydrogen gas production means for producing a second stream of hydrogen gas, said hydrogen gas production means being a non-electrolyzer in communication link with the electrolyzer; (4) a first conduit leading to a hydrogen gas user through which a mixed stream of hydrogen gas comprised of a mixture of the first stream of hydrogen gas and the second stream of hydrogen gas flows to the hydrogen gas user at the exit end thereof; (5) a second conduit connecting the electrolyzer to the first conduit and through which flows the first stream of hydrogen gas produced by the electrolyzer at a first rate flows into the first conduit; (6) a third conduit connecting hydrogen gas production means to the first conduit through which flows the second stream of hydrogen gas produced by the hydrogen gas production means at a second flow rate, the second stream of hydrogen gas entering the third conduit at a location different from where the hydrogen gas from the second conduit enters the first conduit to mix with the first stream of hydrogen gas and form a mixed stream of hydrogen gas that flows in the first conduit to the hydrogen gas user, wherein the second conduit and the third conduits are separate conduits; and (7) means for compensating for fluctuations of hydrogen gas production from the electrolyzer for maintaining a continuous flow of hydrogen gas to the hydrogen gas user.

2. The system according to claim 2, where the non-electrolyzer is a steam-methane reformer.

3. The system according to claim 1, wherein the system additionally comprises a first valve located on the first conduit, the first valve being downstream from where the first stream of hydrogen gas produced by the electrolyzer flows from the second conduit into the first conduit and downstream from where the second stream of hydrogen gas produced by the non-electrolyzer flows enters the first conduit and upstream from where the mixed stream of hydrogen gas flows in the first conduit to the hydrogen gas user.

4. The system according to claim 1, where means for compensating for fluctuations of hydrogen gas production from the electrolyzer comprises a signal from the electrolyzer to the non-electrolyzer through the communications link to increase the output of hydrogen gas from the non-electrolyzer at a rate sufficient for maintaining the mixed stream of hydrogen gas flowing to the hydrogen gas user at the predetermined rate during a decrease in electricity relative to a baseline to the electrolyzer and/or a decrease in hydrogen production therefrom.

5. The system according to claim 1, which additionally comprises a hydrogen gas storage facility and a fourth conduit connecting the hydrogen gas storage facility and the first conduit at a location downstream from where the mixed stream of hydrogen gas flows into the first conduit; a fifth conduit through which the third stream of hydrogen gas from the hydrogen gas storage facility flows into the first conduit; and a second valve on the fifth conduit which is configured to open to allow the third stream of hydrogen gas to flow into the first conduit or close to prevent the third stream of hydrogen gas to flow into the first conduit.

6. The system according to claim 4, which additionally comprises a pressure controller that monitors the mixed stream of hydrogen gas flowing to the hydrogen gas user from the first conduit; and a first compressor that is located on the fourth conduit upstream from said hydrogen gas storage facility and configured to control the flow of the mixed stream of hydrogen gas to the hydrogen gas storage facility through the fourth conduit; and a communications link between the pressure controller and the first compressor capable of communicating to the first compressor to cause the mixed hydrogen gas stream either to flow to or prevent the flow to hydrogen gas storage facility and a communications link between the pressure controller and the second valve for communicating to the second valve to open or close.

7. The system according to claim 6, where means for compensating for fluctuations of hydrogen production from the electrolyzer comprises a signal from the pressure controller to the first compressor which causes the mixed stream of hydrogen gas to flow into the hydrogen gas storage facility and from the pressure controller to the second valve to close during a decrease in electricity relative to a baseline to the electrolyzer and a decrease in hydrogen production therefrom.

8. The system according to claim 1, where means for compensating for fluctuations of hydrogen production from the electrolyzer comprises a signal from the electrolyzer to the non-electrolyzer to decrease the output of the second stream of hydrogen gas from the non-electrolyzer. or a signal; from the pressure controller to the first compressor to turn on and a signal to the second valve to close to permit at least a portion of the stream of hydrogen gas from the first conduit to flow into the hydrogen gas storage facility when the consumption of electricity by the electrolyzer is above the baseline.

9. The system according to claim 6, wherein the pressure controller is capable of communicating with the non-electrolyzer to increase or decrease hydrogen gas production therefrom.

10. The system according to claim 1, which additionally comprises a second compressor, located on the second conduit downstream from the electrolyzer, capable of compressing the first stream of hydrogen gas produced from the electrolyzer.

11. The system according to claim 1, which additionally comprises a dryer on the second conduit capable of removing water present in the first stream of hydrogen gas produced by the electrolyzer, the dryer being located downstream from the electrolyzer and upstream from where the first stream of hydrogen gas flowing in said conduit from the electrolyzer flows into the first conduit.

12. The system according to claim 8, which additionally comprises a turbine located on the fourth conduit downstream from the hydrogen gas storage facility, capable of converting the third stream of hydrogen gas flow into mechanical energy.

13. The system according to claim 1, which additionally comprises a hydrogen gas liquefier, a sixth conduit, the entrance end of which is located at a position on the first conduit, and upstream of the hydrogen gas user and downstream from where the first stream of hydrogen gas produced by the electrolyzer flows from the second conduit into the first conduit and downstream from where the second stream of hydrogen gas produced by the non-electrolyzer flows from the third conduit into the first conduit.

14. The system according to claim 13, which additionally comprises a liquid hydrogen reservoir and a seventh conduit connecting the liquid hydrogen liquefier to the liquid hydrogen reservoir.

15. A process for producing hydrogen gas to a consumer which comprises:
(1) providing an electrolyzer generating a first stream of hydrogen gas which is in communications link with an electric power grid, said electric power grid being capable of providing grid services to transmission and distribution system operators to maintain power transfer and distribution and providing a baseline of electricity to the electrolyzer; (2) providing a hydrogen gas production means for producing a second stream of hydrogen, said hydrogen gas production means being a non-electrolyzer in communication link with the electrolyzer; (3) coupling the hydrogen gas production of the electrolyzer with the hydrogen gas production from the non-electrolyzer and controlling the amount of first stream of hydrogen gas and the second stream of hydrogen gas being produced; (4) mixing the first stream of hydrogen gas with the second stream of hydrogen gas to form a mixed stream of hydrogen gas that flows at a predetermined rate in the first conduit to the hydrogen gas user; (5) transporting the mixed stream of hydrogen gas to the hydrogen gas user and (6) compensating for fluctuations of hydrogen gas production from the electrolyzer to maintain a continuous flow of the mixed stream of hydrogen gas to the hydrogen gas user at a predetermined rate.

16. The process according to claim 15, wherein the non-electrolyzer is steam methane reformer.

17. The process according to claim 15, which additionally comprises storing a portion of the mixed stream of hydrogen gas in a hydrogen gas hydrogen gas storage facility.

18. The process according to claim 15, where compensating for fluctuations of hydrogen gas production from the electrolyzer comprises increasing the output of the second stream of hydrogen gas from the non-electrolyzer at a rate sufficient for maintaining the mixed stream of hydrogen gas flowing to the hydrogen gas user at the predetermined rate during a decrease in electricity relative to a baseline to the electrolyzer and a decrease in hydrogen production therefrom.

19. The process according to claim 15, where compensating for fluctuations of hydrogen gas production from the electrolyzer comprises a release of a third stream of hydrogen gas from a hydrogen gas storage facility into the mixed stream of hydrogen gas flowing to the hydrogen gas user at a rate sufficient for maintaining the predetermined rate during a decrease in electricity relative to a baseline to the electrolyzer and a decrease in hydrogen production therefrom.

20. The process according to claim 15, where compensating for fluctuations of hydrogen production from the electrolyzer comprises decreasing the output of the second stream of hydrogen gas from the non-electrolyzer or diverting some of the mixed stream of hydrogen gas flowing to the hydrogen gas user to a hydrogen gas storage facility or a combination of both at a rate sufficient for maintaining the rate of flow of the mixed stream of hydrogen gas to the hydrogen gas user when the consumption of electricity by the electrolyzer is above the baseline.

21. The process of claim 15, further comprising monitoring the hydrogen gas pressure in the mixed stream of hydrogen gas.

22. The process according to claim 15, which additionally comprises controlling the flow of the amount of the mixed stream of hydrogen gas that flows to the hydrogen gas user in the first conduit by passing said mixture through a first valve which controls the amount of the mixed stream of hydrogen gas that flows therethrough.

23. The process according to claim 15, wherein the first stream of hydrogen gas from the electrolyzer is compressed prior to mixing with the second stream of hydrogen gas.

24. The process according to claim 15, wherein the first stream of hydrogen gas is dried in a drier prior to mixing with the second stream of hydrogen gas.

25. The process according to claim 15, wherein a turbine is additionally present and diverting a portion of the mixed stream of hydrogen gas that flows to the hydrogen gas user to the turbine.

26. The process according to claim 15, wherein a hydrogen liquefier is additionally present and diverting a portion of the mixed stream of hydrogen gas that flows to the hydrogen gas user to a hydrogen gas liquefier for liquification thereof.
